(19) United States
(12) Patent Application Publication
(10) Pub. No.: US 2023/0231307 A1
(43) Pub. Date: Jul. 20, 2023

(54) ANTENNA

(71) Applicant: MEDIATEK INC., Hsinchu City (TW)

(72) Inventor: Chung-Hsin CHIANG, Hsinchu City (TW)

(21) Appl. No.: 18/146,570

(22) Filed: Dec. 27, 2022

Related U.S. Application Data
(60) Provisional application No. 63/299,449, filed on Jan. 14, 2022.

(51) Int. Cl. H01Q 5/48; H01Q 21/26; H01Q 9/28; H01Q 21/06

(52) U.S. Cl. CPC H01Q 5/48; H01Q 21/26; H01Q 9/285; H01Q 21/062

(57) ABSTRACT

An antenna device includes a first antenna and a second antenna. The first antenna receives or transmits first radio frequency signals to a first direction. The second antenna receives or transmits second radio frequency signals to a second direction. The first direction is different from the second direction. The first antenna and the second antenna share radiators.

### CROSS REFERENCE TO RELATED APPLICATIONS

This application claims the benefit of U.S. Provisional Application No. 63/299,449, filed on Jan. 14, 2022, the entirety of which is incorporated by reference herein.

### BACKGROUND OF THE INVENTION

### Field of the Invention

The present invention relates to an antenna device, and, in particular, to a wide coverage shared aperture antenna.

### Description of the Related Art

In current smartphone designs, different antennas are used to get coverage in another radiation direction. Therefore, these antennas may be double the necessary size. The BOM cost—including the cost of the antenna substrate and the flexible printed circuit (FPC)—may likewise be nearly double. Furthermore, the coverage of antennas using the current design may cover two sides, and these antennas can only be disposed on the edges of the phone. How to use the same antenna to get another radiation direction while reducing the antenna's size and the BOM cost has become an important topic.

### BRIEF SUMMARY OF THE INVENTION

An embodiment of the present invention provides an antenna device. The antenna device includes a first antenna and a second antenna. The first antenna receives or transmits first radio frequency signals to a first direction. The second antenna receives or transmits second radio frequency signals to a second direction. The first direction is different from the second direction. Radiators of the first antenna and the second antenna are shared.

According to the antenna device described above, the direction-angle difference between the first direction and the second direction is larger than 30 degrees.

According to the antenna device described above, the frequency of the first radio frequency signals is the same as that of the second radio frequency signals; or the frequency of the first radio frequency signals is different from that of the second radio frequency signals.

According to the antenna device described above, the first antenna is a dipole antenna, and the second antenna is a planar inverted-F (PIFA) liked antenna.

According to the antenna device described above, the first antenna includes a first feed line. The second antenna includes a second feed line. The first feed line electrically couples the first radio frequency signals to the radiators of the first antenna. The second feed line electrically connects or couples the second radio frequency signals to the radiators of the second antenna.

According to the antenna device described above, the second antenna includes a tuning circuit. The tuning circuit is electrically connected to the second feed line or to the radiators of the second antenna.

According to the antenna device described above, the first antenna includes a tuning circuit. The tuning circuit is electrically connected to the first feed line or to the radiators of the first antenna.

According to the antenna device described above, the tuning circuit includes a phase shifter and a switch. The phase shifter delays the phase of the second radio frequency signals. The switch shorts the second feed line to a ground, or opens the second feed line.

According to the antenna device described above, the phase shifter includes a variable capacitor and a transmission line. The variable capacitor is electrically connected in parallel between the second feed line and the ground, and it changes the impedance of the second feed line. The transmission line is electrically connected to the second feed line in series, and it delays the phase of the second radio frequency signals.

According to the antenna device described above, the radiators of the first antenna include a first portion and a second portion. The first feed line is disposed between the first portion and the second portion. The first portion and the second portion form the shape of a pair of gull wings.

According to the antenna device described above, the radiators of the second antenna include the first portion of the radiators of the first antenna, the second feed line, and a ground.

According to the antenna device described above, when the first antenna receives or transmits the first radio frequency signals to the first direction, the switch opens the second feed line. When the second antenna receives or transmits the second radio frequency signals to the second direction, the switch shorts the second feed line to the ground.

According to the antenna device described above, the antenna device further includes a third antenna. The third antenna receives or transmits third radio frequency signals to a third direction. The third direction and the second direction are in opposite directions. The radiators of the first antenna and the third antenna are shared.

According to the antenna device described above, the third antenna includes a third feed line. The third feed line is electrically connects or couples the third radio frequency signals to the radiators of the third antenna.

According to the antenna device described above, the third antenna is a planar inverted-F (PIFA) antenna.

According to the antenna device described above, the polarization direction of the first radio frequency signals is the same as the second direction or the opposite direction of the second direction. The polarization direction of the second frequency signals is the same as the first direction or the opposite direction of the first direction.

According to the antenna device described above, the antenna device further includes a fourth antenna. The fourth antenna receives or transmits fourth radio frequency signals to the first direction. The polarization direction of the fourth radio frequency signals is a fourth direction. The fourth direction is orthogonal to the second direction.

According to the antenna device described above, the fourth antenna includes a fourth feed line. The fourth feed line is electrically couples the fourth radio frequency signals to the radiators of the fourth antenna.

According to the antenna device described above, the fourth antenna is a dipole antenna.

According to the antenna device described above, the radiators of the fourth antenna include a third portion and a fourth portion. The fourth feed line is disposed between the third portion and the fourth portion. The third portion and the fourth portion form the shape of a pair of gull wings.

### BRIEF DESCRIPTION OF THE DRAWINGS

The disclosure can be more fully understood by reading the subsequent detailed description with references made to the accompanying figures. It should be understood that the figures are not drawn to scale in accordance with standard practice in the industry. In fact, it is allowed to arbitrarily enlarge or reduce the size of components for clear illustration. This means that many special details, relationships and methods are disclosed to provide a complete understanding of the disclosure.

FIG. 1A is a schematic diagram of an antenna device in accordance with some embodiments of the present invention.

FIG. 1B is a schematic diagram of an antenna device in accordance with some embodiments of the present invention.

FIG. 1C is a schematic diagram of an antenna device in accordance with some embodiments of the present invention.

FIG. 2A is a stereogram of an antenna device in accordance with some embodiments of the present invention.

FIG. 2B is a block diagram of the antenna device in FIG. 2A in accordance with some embodiments of the present invention.

FIG. 3A is a schematic diagram of an antenna device in accordance with some embodiments of the present invention.

FIG. 3B is a schematic diagram of a tuning circuit in FIG. 3A in accordance with some embodiments of the present invention.

FIG. 3C is a detail schematic diagram of a tuning circuit in FIG. 3A in accordance with some embodiments of the present invention.

FIG. 4A is a schematic diagram of an antenna device in accordance with some embodiments of the present invention.

FIG. 4B is a block diagram of the antenna device in FIG. 4A in accordance with some embodiments of the present invention.

FIG. 5A is a schematic diagram of an antenna device in accordance with some embodiments of the present invention.

FIG. 5B is a block diagram of the antenna device in FIG. 5A in accordance with some embodiments of the present invention.

FIG. 6A is a schematic diagram of an antenna device in accordance with some embodiments of the present invention.

FIG. 6B is a schematic diagram of an antenna array including the antenna device in FIG. 6A in accordance with some embodiments of the present invention.

FIG. 6C is a block diagram of the antenna device in FIG. 6A in accordance with some embodiments of the present invention.

FIG. 7 is a schematic diagram of an antenna control system including the antenna device in FIG. 2B in accordance with some embodiments of the present invention.

FIG. 8 is a schematic diagram of an antenna control system in accordance with some embodiments of the present invention.

FIG. 9 is a schematic diagram of an antenna control system in accordance with some embodiments of the present invention.

FIG. 10 is a schematic diagram of an antenna control system in accordance with some embodiments of the present invention.

FIG. 11 is a schematic diagram of an antenna control system in accordance with some embodiments of the present invention.

FIG. 12 is a schematic diagram of an antenna control system in accordance with some embodiments of the present invention.

FIG. 13A is a schematic diagram of an antenna device in accordance with some embodiments of the present invention.

FIG. 13B is a schematic diagram of the antenna device in FIG. 13A in accordance with some embodiments of the present invention.

FIG. 14A is a schematic diagram of an antenna device in accordance with some embodiments of the present invention.

FIG. 14B is a schematic diagram of the antenna device in FIG. 14A in accordance with some embodiments of the present invention.

### DETAILED DESCRIPTION OF THE DISCLOSURE

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present invention.

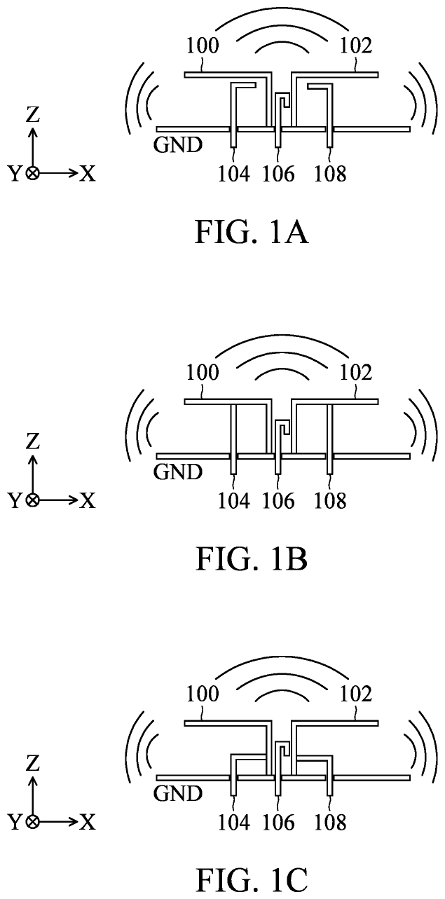

FIG. 1A is a schematic diagram of an antenna device in accordance with some embodiments of the present invention. As shown in FIG. 1A, the antenna device includes a first antenna, a second antenna, and a third antenna. The first antenna includes a radiator 100, a radiator 102, and a feed line 106. The first antenna receives or transmits first radio frequency signals to a first direction (e.g., the Z direction). The feed line 106 electrically couples the first radio frequency signals to the radiators 100 and 102 of the first antenna. The feed line 106 passes through a ground GND along the Z direction and is disposed between the radiators 100 and 102, and the radiators 100 and 102 form the shape of a pair of gull wings, but the present invention is not limited thereto. The polarization direction of the first radio frequency signals transmitted from the first antenna is the same as the X direction or the −X direction. In some embodiments, the first antenna is a dipole antenna, but the present invention is not limited thereto.

The second antenna includes the radiator 100, the ground GND, and a feed line 104. The radiator 100 is shared by the first antenna and the second antenna. The second antenna receives or transmits second radio frequency signals to a second direction (e.g., the −X direction). The feed line 104 electrically couples the second radio frequency signals to the radiator 100 of the second antenna. The feed line 104 passes through the ground GND along the Z direction and is covered by the radiator 100 in view of the −Z direction. The feed line 104 and the radiator 100 form the shape of an inverted F, but the present invention is not limited thereto. The polarization direction of the second radio frequency signals transmitted from the second antenna is the same as the Z direction or the −Z direction. In some embodiments, the second antenna is a planar inverted-F (PIFA) liked antenna, but the present invention is not limited thereto.

The third antenna includes the radiator 102, the ground GND, and a feed line 108. The radiator 102 is shared by the first antenna and the third antenna. The third antenna receives or transmits third radio frequency signals to a third direction (e.g., the X direction). The feed line 108 electrically couples the third radio frequency signals to the radiator 102 of the third antenna. The feed line 108 passes through the ground GND along the Z direction and is covered by the radiator 102 in view of the −Z direction. The feed line 108 and the radiator 102 form the shape of an inverted F, but the present invention is not limited thereto. The polarization direction of the third radio frequency signals transmitted from the third antenna is the same as the Z direction or the −Z direction. In some embodiments, the third antenna is a PIFA antenna, but the present invention is not limited thereto. In some embodiments, the frequency of the first radio frequency signals is the same or different from that of the second radio frequency signals. The frequency of the second radio frequency signals is the same or different from that of the third radio frequency signals. The frequency of the third radio frequency signals is the same or different from that of the first radio frequency signals.

FIG. 1B is a schematic diagram of an antenna device in accordance with some embodiments of the present invention. The difference between the antenna device in FIG. 1B and the antenna device FIG. 1A is that the feed line 104 of the second antenna in FIG. 1B electrically connects the second radio frequency signals to the radiator 100 of the second antenna, and the feed line 108 of the third antenna in FIG. 1B electrically connects the third radio frequency signals to the radiator 102 of the third antenna. In some embodiments, the feed line 104 of the second antenna electrically connects to the horizontal (e.g., the X direction) portion of the radiator 100. The feed line 108 of the third antenna electrically connects to the vertical (e.g. the Z direction) portion of the radiator 102.

FIG. 1C is a schematic diagram of an antenna device in accordance with some embodiments of the present invention. The difference between the antenna device in FIG. 1C and the antenna device FIG. 1A is that the feed line 104 of the second antenna in FIG. 1C electrically connects the second radio frequency signals to the radiator 100 of the second antenna, and the feed line 108 of the third antenna in FIG. 1C electrically connects the third radio frequency signals to the radiator 102 of the third antenna. In some embodiments, the feed line 104 of the second antenna electrically connects to the vertical (e.g., the Z direction) portion of the radiator 100. The feed line 108 of the third antenna electrically connects to the horizontal (e.g. the X direction) portion of the radiator 102.

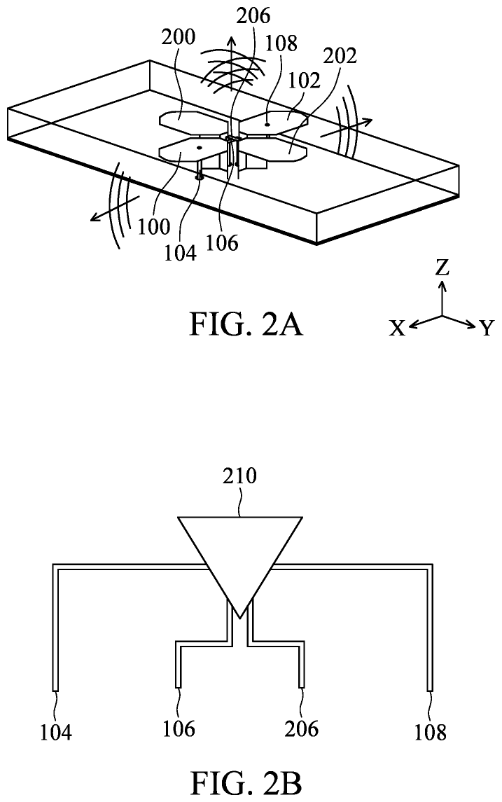

FIG. 2A is a stereogram of an antenna device in accordance with some embodiments of the present invention. As shown in FIG. 2A, the antenna device includes a the first antenna in FIG. 1B, the second antenna in FIG. 1B, the third antenna in FIG. 1B, and a fourth antenna. The fourth antenna receives or transmits fourth radio frequency signals to the first direction (e.g., the Z direction). The fourth antenna includes a radiator 200, a radiator 202, and a feed line 206. The feed line 206 electrically couples the fourth radio frequency signals to the radiators 200 and 202 of the fourth antenna. The feed line 206 passes through the ground GND along the Z direction and is disposed between the radiators 200 and 202, and the radiators 200 and 202 form the shape of a pair of gull wings, but the present invention is not limited thereto. Both feed lines 106 and 206 are surrounded by the radiators 100, 102, 200, and 202, but the present invention is not limited thereto. The polarization direction of the fourth radio frequency signals transmitted from the fourth antenna is the same as the Y direction or the −Y direction in FIG. 2A. However, the polarization direction of the first radio frequency signals transmitted from the first antenna is the same as the X direction or the −X direction in FIG. 2A. In other words, the polarization direction of the fourth radio frequency signals is orthogonal to that of the first radio frequency signals. In some embodiments, the fourth antenna is a dipole antenna, but the present invention is not limited thereto. In some embodiments, the angle difference between the first direction (e.g., the Z direction in FIG. 2A) and the second direction (e.g., the X direction in FIG. 2A) is larger than 30 degrees. For example, the angle difference between the Z direction in FIG. 2A and the X direction in FIG. 2A is 90 degrees, but the present invention is not limited thereto.

FIG. 2B is a block diagram of the antenna device in FIG. 2A in accordance with some embodiments of the present invention. As shown in FIG. 2B, the antenna device 210 includes the first antenna, the second antenna, the third antenna, and the fourth antenna in FIG. 2A. In detail, the first antenna includes the feed line 106 to receive or transmit the first radio frequency signals. The second antenna includes the feed line 104 to receive or transmit the second radio frequency signals. The third antenna includes the feed line 108 to receive or transmit the third radio frequency signals. The fourth antenna includes the feed line 206 to receive or transmit the fourth radio frequency signals. The first radio frequency signals are radiated by the radiators 100 and 102 of the first antenna. The second radio frequency signals are radiated by the radiator 100 and the feed line 104 of the second antenna, and the ground GND. The third radio frequency signals are radiated by the radiator 102 and the feed line 108 of the third antenna, and the ground GND. The fourth radio frequency signals are radiated by the radiators 200 and 202 of the fourth antenna. In some embodiments, the frequency of the fourth radio frequency signals is the same or different from that of the first radio frequency signals.

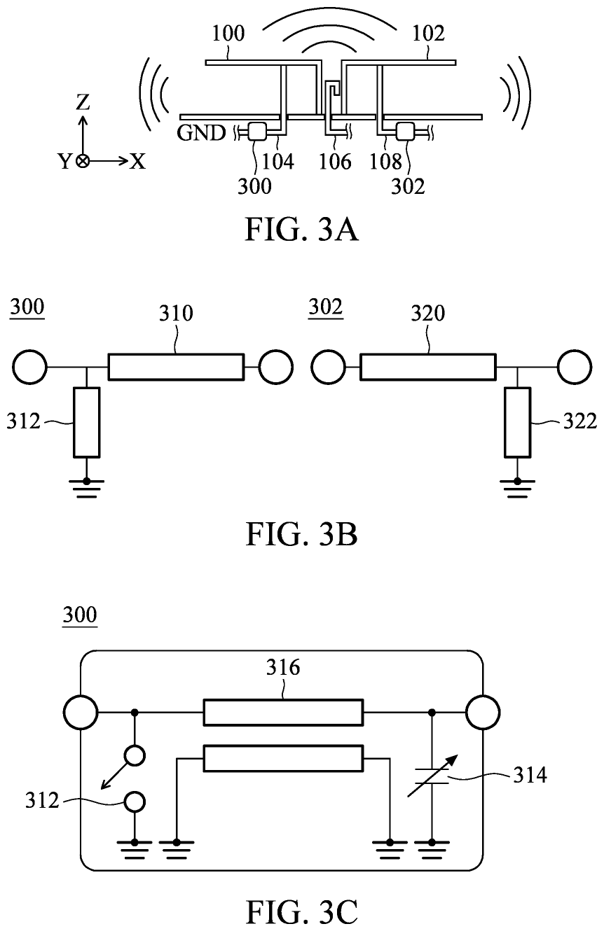

FIG. 3A is a schematic diagram of an antenna device in accordance with some embodiments of the present invention. The difference between the antenna device in FIG. 3A and the antenna device in FIG. 1B is that the second antenna further includes a tuning circuit 300 electrically connected in series on the feed line 104, and the third antenna further includes a tuning circuit 302 electrically connected in series on the feed line 108. The tuning circuit 300 is the same as the tuning circuit 302. FIG. 3B is a schematic diagram of the tuning circuit 300 in FIG. 3A in accordance with some embodiments of the present invention. The tuning circuit 300 includes a phase shifter 310 and a switch 312. The tuning circuit 302 includes a phase shifter 320 and a switch 322. The phase shifter 310 delays the phase of the second radio frequency signals. The switch 312 shorts the feed line 104 to the ground GND or opens the second feed line 104 according which antenna is currently under work. The phase shifter 320 delays the phase of the third radio frequency signals. The switch 322 shorts the feed line 108 to the ground GND or opens the second feed line 108 according which antenna is currently under work. For example, when the first antenna including the radiators 100 and 102, and the feed line 106 is under work, the first antenna receives or transmits the first radio frequency signals to the first direction (e.g., the Z direction), the switch 312 shorts the feed line 104 to the ground GND and the switch 322 shorts the feed line 108 to the ground GND.

In some embodiments, when the second antenna including the radiator 100, the feed line 104, and the ground GND is currently under work, the second antenna receives or transmits the second radio frequency signals to the second direction (e.g., the −X direction), the switch 312 opens the feed line 104 and the switch 322 shorts the feed line 108 to the ground GND. In some embodiments, when the third antenna including the radiator 102, the feed line 108, and the ground is currently under work, the third antenna receives or transmits the third radio frequency signals to the third direction (e.g., the X direction), the switch 322 opens the feed line 108 and the switch 312 shorts the feed line 104 to the ground GND.

FIG. 3C is a detail schematic diagram of the tuning circuit 300 in FIG. 3A in accordance with some embodiments of the present invention. As shown in FIG. 3C, the phase shifter 310 in FIG. 3B includes a variable capacitor 314 and a delay line 316. The variable capacitor 314 is electrically connected in parallel between the feed line 104 and the ground GND, and changes the impedance of the feed line 104. The delay line 316 is electrically connected to the feed line 104 in series, and delays the phase of the second radio frequency signals. The switch 312 is electrically connected in parallel between the feed line 104 and the ground GND. By tuning the capacitance of the variable capacitor 314 and/or the length of the delay line 316, the impedance of the feed line 104 can be match to a predetermined value (for example, 50 ohms). Similarly, the phase shifter 320 in FIG. 3B includes a variable capacitor (not shown) and a delay line (not shown). The variable capacitor in the phase shifter 320 is electrically connected in parallel between the feed line 108 and the ground GND, and changes the impedance of the feed line 108. The delay line in the phase shifter 320 is electrically connected to the feed line 108 in series, and delays the phase of the third radio frequency signals. The switch 322 is electrically connected in parallel between the feed line 108 and the ground GND. By tuning the capacitance of the variable capacitor in the phase shifter 320 and/or the length of the delay line in the phase shifter 320, the impedance of the feed line 108 can be match to a predetermined value (for example, 50 ohms).

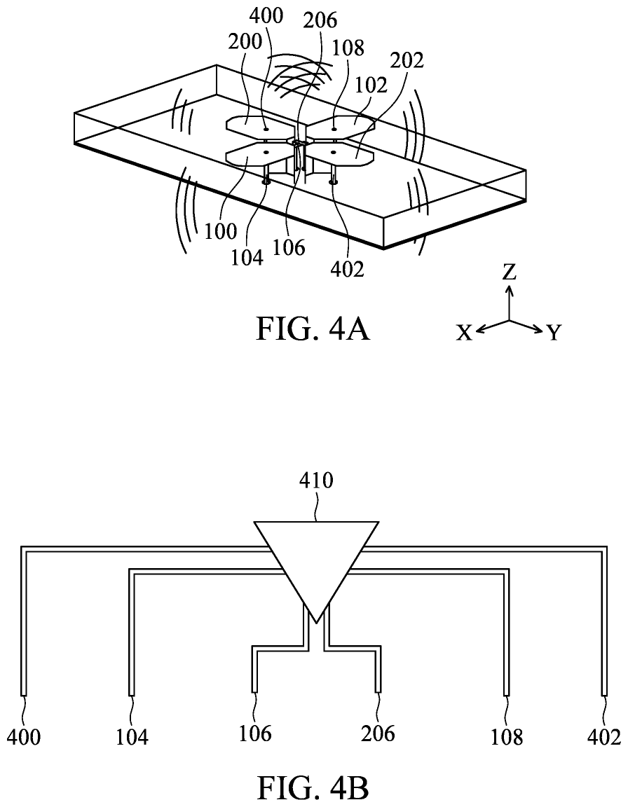

FIG. 4A is a schematic diagram of an antenna device in accordance with some embodiments of the present invention. The difference between the antenna device in FIG. 4A and the antenna device in FIG. 2A is that the antenna device in FIG. 4A further includes a fifth antenna including the radiator 200, a feed line 400, and the ground GND, and a sixth antenna including the radiator 202, a feed line 402, and the ground. The fifth antenna receives or transmits fifth radio frequency signals to the −Y direction. The feed line 400 electrically connects the fifth radio frequency signals to the radiator 200. The feed line 400 passes through the ground GND along the Z direction and is covered by the radiator 200 in view of the −Z direction. The radiator 200 is shared by the fourth antenna and the fifth antenna. The polarization direction of the fifth radio frequency signals is the same as the Z direction or the −Z direction. The sixth antenna receives or transmits sixth radio frequency signals to the Y direction. The feed line 402 electrically connects the sixth radio frequency signals to the radiator 202. The feed line 402 passes through the ground GND along the Z direction and is covered by the radiator 202 in view of the −Z direction. The radiator 202 is shared by the fourth antenna and the sixth antenna. The polarization direction of the sixth radio frequency signals is the same as the Z direction or the −Z direction. In some embodiments, the fifth antenna and the sixth antenna are PIFA antenna, but the present invention is not limited thereto.

FIG. 4B is a block diagram of the antenna device in FIG. 4A in accordance with some embodiments of the present invention. As shown in FIG. 4B, the antenna device 410 includes the first antenna, the second antenna, the third antenna, the fourth antenna, the fifth antenna, and the sixth antenna in FIG. 4A. In detail, the first antenna includes the feed line 106 to receive or transmit the first radio frequency signals. The second antenna includes the feed line 104 to receive or transmit the second radio frequency signals. The third antenna includes the feed line 108 to receive or transmit the third radio frequency signals. The fourth antenna includes the feed line 206 to receive or transmit the fourth radio frequency signals. The fifth antenna includes the feed line 400 to receive or transmit the fifth radio frequency signals. The sixth antenna includes the feed line 402 to receive or transmit the sixth radio frequency signals.

In some embodiments of FIG. 4A and FIG. 4B, the first radio frequency signals are radiated by the radiators 100 and 102 of the first antenna. The second radio frequency signals are radiated by the radiator 100 and the feed line 104 of the second antenna, and the ground GND. The third radio frequency signals are radiated by the radiator 102 and the feed line 108 of the third antenna, and the ground GND. The fourth radio frequency signals are radiated by the radiators 200 and 202 of the fourth antenna. The fifth radio frequency signals are radiated by the radiator 200 and the feed line 400 of the fifth antenna, and the ground GND. The sixth radio frequency signals are radiated by the radiator 202 and the feed line 402 of the sixth antenna, and the ground GND.

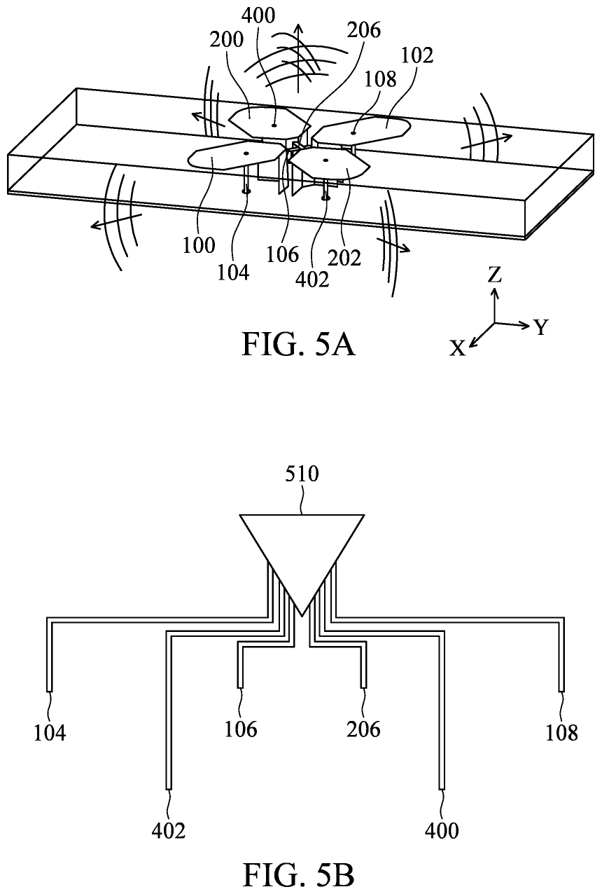

FIG. 5A is a schematic diagram of an antenna device in accordance with some embodiments of the present invention. The difference between the antenna device in FIG. 5A and the antenna device in FIG. 4A is that the antenna device in FIG. 5A is obtained by clockwise rotating the antenna device in FIG. 4A about 45 degrees. That is, the first antenna including the radiators 100 and 102, and the feed line 106 receives or transmits the first radio frequency signals to the Z direction. However, the polarization direction of the first radio frequency signals is equal to the direction between the X direction and the −Y direction. In detail, the polarization direction of the first radio frequency signals is equal to the direction with the direction-angle difference of −45 degrees from the X direction, or the direction with the direction-angle difference of 135 degrees from the X direction. In some embodiments, the second antenna including the radiator 100, the feed line 104, and the ground GND receives or transmits the second radio frequency signals to the direction between the X direction and the −Y direction. In detail, the direction between the X direction and the −Y direction may be the direction with the direction-angle difference of −45 degrees from the X direction. The polarization direction of the second radio frequency signals is equal to the Z direction or the −Z direction.

The third antenna including the radiator 102, the feed line 108, and the ground GND receives or transmits the third radio frequency signals to the direction between the −X direction and the Y direction. In detail, the direction between the −X direction and the Y direction may be the direction with the direction-angle difference of 135 degrees from the X direction. The polarization direction of the third radio frequency signals is equal to the Z direction or the −Z direction. The fourth antenna including the radiators 200 and 202, and the feed line 206 receives or transmits the fourth radio frequency signals to the Z direction. However, the polarization direction of the fourth radio frequency signals is equal to the direction between the X direction and the Y direction. In detail, the polarization direction of the fourth radio frequency signals is equal to the direction with the direction-angle difference of 45 degrees from the X direction.

In some embodiments, the fifth antenna including the radiator 200, the feed line 400, and the ground GND receives or transmits the fifth radio frequency signals to the direction between the −X direction and the −Y direction. In detail, the direction between the −X direction and the −Y direction may be the direction with the direction-angle difference of −135 degrees from the X direction. The polarization direction of the fifth radio frequency signals is equal to the Z direction or the −Z direction. The sixth antenna including radiator 202, the feed line 402, and the ground GND receives or transmits the sixth radio frequency signals to the direction between the X direction and the Y direction. The direction between the X direction and the Y direction may be the direction with the direction-angle difference of 45 degrees from the X direction. The polarization direction of the sixth radio frequency signals is equal to the Z direction or the −Z direction.

FIG. 5B is a block diagram of the antenna device in FIG. 5A in accordance with some embodiments of the present invention. As shown in FIG. 5B, the antenna device 510 includes the first antenna, the second antenna, the third antenna, the fourth antenna, the fifth antenna, and the sixth antenna in FIG. 5A. In detail, the first antenna includes the feed line 106 to receive or transmit the first radio frequency signals. The second antenna includes the feed line 104 to receive or transmit the second radio frequency signals. The third antenna includes the feed line 108 to receive or transmit the third radio frequency signals. The fourth antenna includes the feed line 206 to receive or transmit the fourth radio frequency signals. The fifth antenna includes the feed line 400 to receive or transmit the fifth radio frequency signals. The sixth antenna includes the feed line 402 to receive or transmit the sixth radio frequency signals.

In some embodiments of FIG. 5A and FIG. 5B, the first radio frequency signals are radiated by the radiators 100 and 102 of the first antenna. The second radio frequency signals are radiated by the radiator 100 and the feed line 104 of the second antenna, and the ground GND. The third radio frequency signals are radiated by the radiator 102 and the feed line 108 of the third antenna, and the ground GND. The fourth radio frequency signals are radiated by the radiators 200 and 202 of the fourth antenna. The fifth radio frequency signals are radiated by the radiator 200 and the feed line 400 of the fifth antenna, and the ground GND. The sixth radio frequency signals are radiated by the radiator 202 and the feed line 402 of the sixth antenna, and the ground GND.

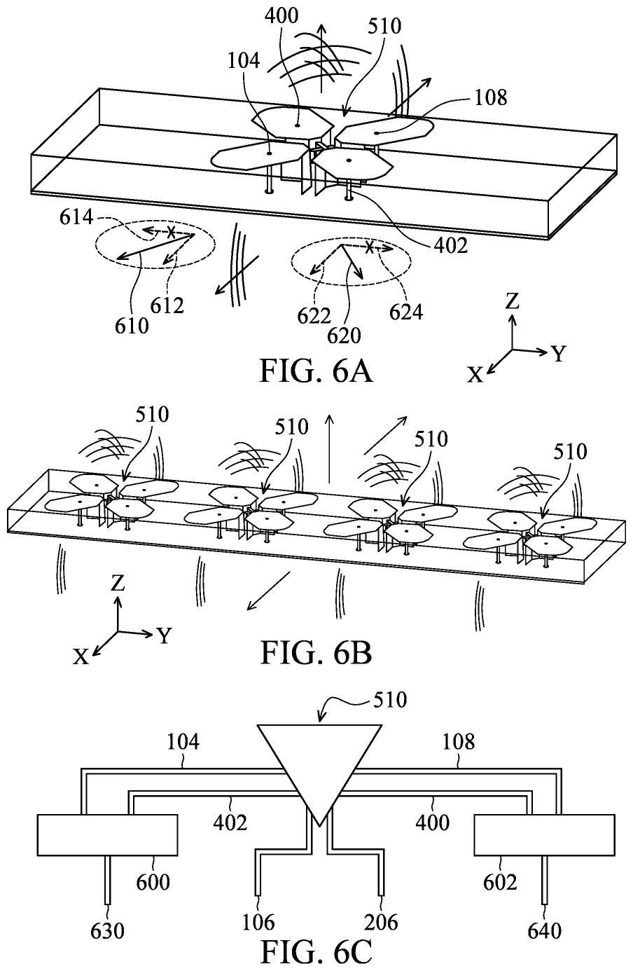

FIG. 6A is a schematic diagram of an antenna device in accordance with some embodiments of the present invention. The difference between the antenna device 510 in FIG. 6A and the antenna device in FIG. 5A is that the second radio frequency signals transmitted from the second antenna including the radiator 100, the feed line 104, and the ground GND are combined with the sixth radio frequency signals transmitted from the sixth antenna including the radiator 202, the feed line 402, and the ground GND. Furthermore, the fifth radio frequency signals transmitted from the fifth antenna including the radiator 200, the feed line 400, and the ground GND are combined with the third radio frequency signals transmitted from the third antenna including the radiator 102, the feed line 108, and the ground GND. For example, the second radio frequency signals are propagated to the direction 610, and the sixth radio frequency signals are propagated to the direction 620. The first subcomponents of the second radio frequency signals propagated to the direction 612 are combined with the first subcomponents of the sixth radio frequency signals propagated to the direction 622. The direction 612 is the same as the direction 622. In some embodiments, the directions 612 and 622 are the same as the X direction. However, due to the direction 614 is opposite to the direction 624, the second subcomponents of the second radio frequency signals propagated to the direction 614 and the second subcomponents of the sixth radio frequency signals propagated to the direction 624 are cancelled by each other.

FIG. 6B is a schematic diagram of an antenna array including the antenna device in FIG. 6A in accordance with some embodiments of the present invention. As shown in FIG. 6B, the antenna array includes four antenna devices 510 in FIG. 6A, but the present invention is not limited thereto. When the second antenna and the sixth antenna in each of the antenna device are under work, the antenna array in FIG. 6B may transmit the combined radio frequency signals to the X direction (e.g., the directions 612 and 622) with higher gain and narrow beam width due to physical characteristics of the antenna array. FIG. 6C is a block diagram of the antenna device in FIG. 6A in accordance with some embodiments of the present invention. As shown in FIG. 6C, the antenna device further includes a combiner 600 and a combiner 602. The combiner 600 combines the feed line 104 of the second antenna and the feed line 402 of the sixth antenna to obtain a combined feed line 630. The combiner 602 combines the feed line 108 of the third antenna and the feed line 400 of the fifth antenna to obtain a combined feed line 640. In some embodiments, the combined feed line 630 controls the antenna array to receive or transmit the combined radio frequency signals to the X direction. The combined feed line 640 controls the antenna array to receive or transmit the combined radio frequency signals to the −X direction. The feed lines 106 and 206 controls the antenna array to receive or transmit the radio frequency signals to the Z direction with different polarization directions, respectively.

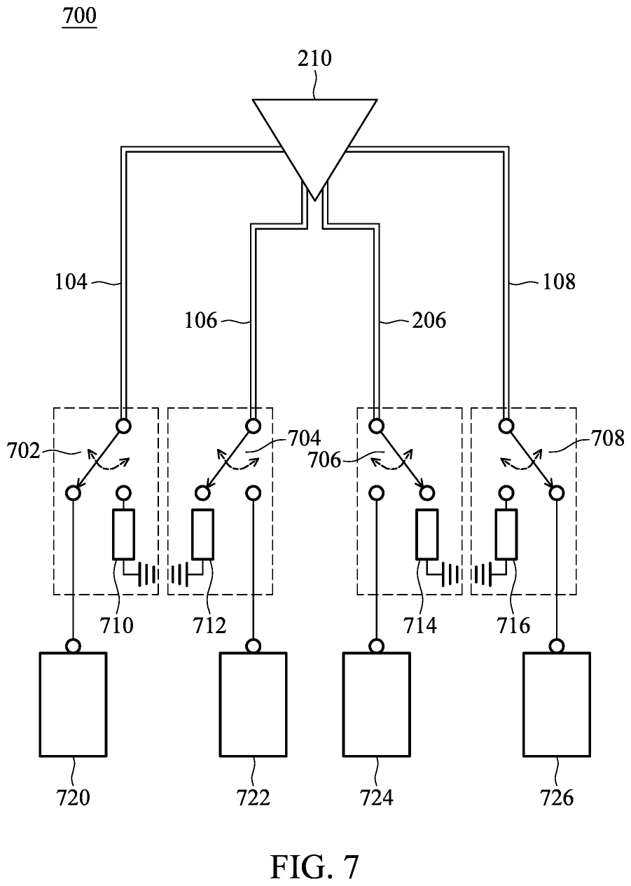

FIG. 7 is a schematic diagram of an antenna control system 700 including the antenna device 210 in FIG. 2B in accordance with some embodiments of the present invention. As shown in FIG. 7, the feed line 104 of the second antenna in the antenna device 210 is electrically connected to an SPDT switch 702. The first output end of the SPDT switch 702 is electrically connected to an RF terminal (T/R) 720. The second output end of the SPDT switch 702 is electrically connected to a load 710. The feed line 106 of the first antenna in the antenna device 210 is electrically connected to an SPDT switch 704. The first output end of the SPDT switch 704 is electrically connected to a load 712. The second output end of the SPDT switch 704 is electrically connected to an RF terminal 722. The feed line 206 of the fourth antenna in the antenna device 210 is electrically connected to an SPDT switch 706. The first output end of the SPDT switch 706 is electrically connected to an RF terminal 724. The second output end of the SPDT switch 706 is electrically connected to a load 714. The feed line 108 of the third antenna in the antenna device 210 is electrically connected to an SPDT switch 708. The first output end of the SPDT switch 708 is electrically connected to a load 716. The second output end of the SPDT switch 708 is electrically connected to an RF terminal 726. In some embodiments, the loads 710, 712, 714, and 716 may be, for example, impedance tuners, open traces, short traces, tuning capacitors, tuning inductors, and phase shifters, but the present invention is not limited thereto. In some embodiments, the RF terminals 720, 722, 724, and 726 are RF function ports of an RFIC (for example, a transceiver), but the present invention is not limited thereto.

For example, when the first antenna and the fourth antenna in the antenna device 210 are under work, the feed line 106 is electrically connected to the RF terminal 722 through the SPDT switch 704, and the feed line 206 is electrically connected to the RF terminal 724 through the SPDT switch 706. At the same time, the second antenna and the third antenna in the antenna device 210 are not under work, the feed line 104 is electrically connected to the load 710 through the SPDT switch 702, and the feed line 108 is electrically connected to the load 716 through the SPDT switch 708.

In some embodiments, when the second antenna and the third antenna in the antenna device 210 are under work, the feed line 104 is electrically connected to the RF terminal 720 through the SPDT switch 702, and the feed line 108 is electrically connected to the RF terminal 726 through the SPDT switch 708. At the same time, the first antenna and the fourth antenna in the antenna device 210 are not under work, the feed line 106 is electrically connected to the load 712 through the SPDT switch 704, and the feed line 206 is electrically connected to the load 714 through the SPDT switch 706.

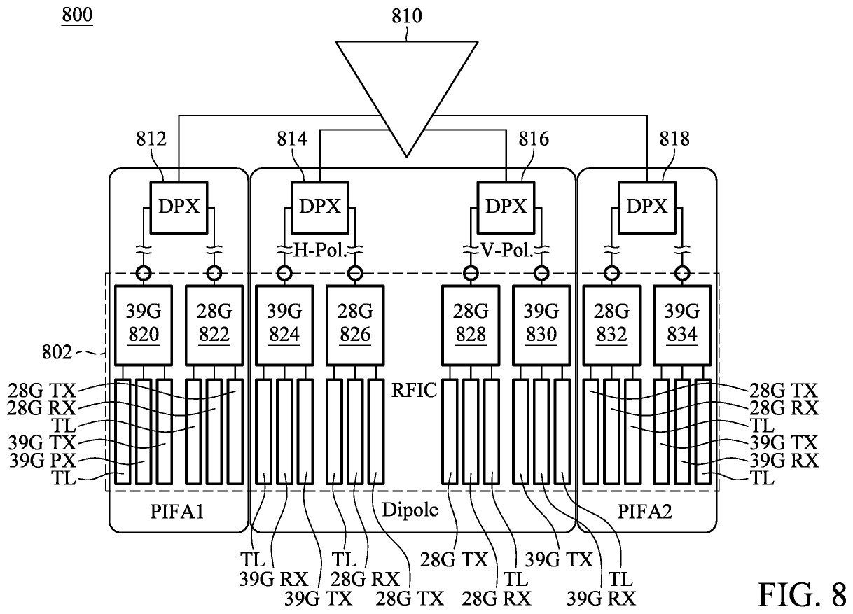

FIG. 8 is a schematic diagram of an antenna control system 800 in accordance with some embodiments of the present invention. As shown in FIG. 8, the antenna control system 800 includes an antenna device 810, a diplexer (DPX) 812, a diplexer 814, a diplexer 816, a diplexer 818, and an RFIC 802. In some embodiments, the diplexer 812 is used for a first PIFA antenna (PIFA1), the diplexer 814 is used for a first dipole antenna (Dipole), the diplexer 816 is used for a second dipole antenna (Dipole), and the diplexer 818 is used for a second PIFA antenna (PIFA2). In some embodiments, the RFIC 802 includes switches 820, 822, 824, 826, 828, 830, 832, and 834. The switches 820, 824, 830 834 are used to control the receiving (the block 39G RX) or transmitting (the block 39G TX) of high band RF signals (e.g., the 39 GHz RF signals) or to connect the respective diplexers to the tuning load TL. The switches 822, 826, 828, and 832 are used to control the receiving (the block 28G RX) or transmitting (the block 28G TX) of low band RF signals (e.g., the 28 GHz RF signals) or to connect the respective diplexers to the tuning load TL.

Please refer to FIG. 2A and FIG. 8 at the same time. In some embodiments, the antenna device 810 includes the first PIFA antenna (the second antenna in FIG. 2A), the first dipole antenna (the first antenna in FIG. 2A), the second dipole antenna (the fourth antenna in FIG. 2A), and the second PIFA antenna (the third antenna in FIG. 2A). The feed line of the first PIFA antenna is electrically connected to the diplexer 812. The feed line of the first dipole antenna is electrically connected to the diplexer 814. The feed line of the second dipole antenna is electrically connected to the diplexer 816. The feed line of the second PIFA antenna is electrically connected to the diplexer 818. In some embodiments, when the first dipole antenna and the second dipole antenna are under work to transmit the high band RF signals with different polarization directions (e.g., the polarization directions H-Pol. and V-Pol.) to the Z direction, the diplexer 814 electrically connects the feed line of the first dipole antenna to the switch 824, and the switch 824 enables the transmitting of the high band RF signals (39G TX). Similarly, the diplexer 816 electrically connects the feed line of the second dipole antenna to the switch 830, and the switch 830 also enables the transmitting of the high band RF signals (39G TX).

At the same time, the first PIFA antenna and the second PIFA antenna are not under work, the diplexer 812 electrically connects the feed line of the first PIFA antenna to the switch 820, and the switch 820 electrically connects the tuning load TL to the diplexer 812. Similarly, the diplexer 818 electrically connects the feed line of the second PIFA antenna to the switch 834, and the switch 834 electrically connects the tuning load TL to the diplexer 818.

In some embodiments, when the first PIFA antenna is under work to receive the low band RF signals from the X direction, the diplexer 812 electrically connects the feed line of the first PIFA antenna to the switch 822, and the switch 822 enables the receiving of the low band RF signals (28G RX). At the same time, the second PIFA antenna, the first dipole antenna, and the second dipole antenna are not work, the diplexer 818 electrically connects the feed line of the second PIFA antenna to the switch 832, and the switch 832 electrically connects the tuning load TL to the diplexer 812. The diplexer 814 electrically connects the feed line of the first dipole antenna to the r the switch 826, and the switch 824 electrically connects the tuning load TL to the diplexer 814. Similarly, the diplexer 816 electrically connects the feed line of the second dipole antenna to the switch 828, and the switch 828 electrically connects the tuning load TL to the diplexer 816.

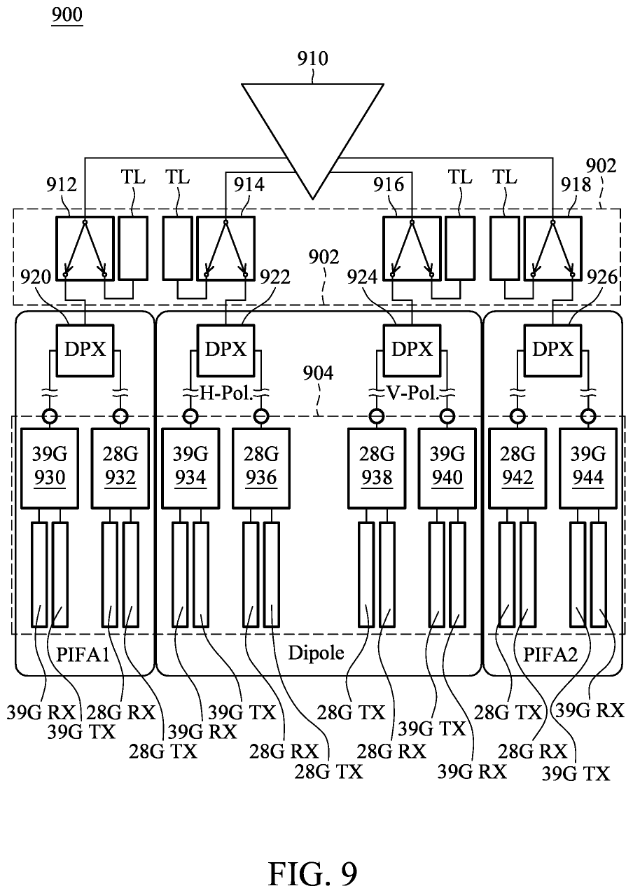

FIG. 9 is a schematic diagram of an antenna control system 900 in accordance with some embodiments of the present invention. As shown in FIG. 9, the antenna control system 900 includes an antenna device 910, an external IC 902 nearby the antenna device 910, diplexers (DPX) 920, 922, 924, and 926, and an RFIC 904. Please refer to FIG. 2A and FIG. 9 at the same time. In some embodiments, the antenna device 910 includes a first PIFA antenna (PIFA1), a second PIFA antenna (PIFA2), a first dipole antenna (Dipole), and a second dipole antenna (Dipole). The external IC 902 includes switches 912, 914, 916, and 918, and tuning loads TL. The input end of the switch 912 electrically connects to the feed line of the first PIFA antenna. The first output end of the switch 912 electrically connects to the diplexer 920. The second output end of the switch 912 electrically connects to the tuning load TL. The input end of the switch 914 electrically connects to the feed line of the first dipole antenna. The first output end of the switch 914 electrically connects to the tuning load TL. The second output end of the switch 914 electrically connects to the diplexer 922. The input end of the switch 916 electrically connects to the feed line of the second dipole antenna. The first output end of the switch 916 electrically connects to the diplexer 924. The second output end of the switch 916 electrically connects to the tuning load TL. The input end of the switch 918 electrically connects to the feed line of the second PIFA antenna. The first output end of the switch 918 electrically connects to the tuning load TL. The second output end of the switch 918 electrically connects to the diplexer 926. In some embodiments, the tuning load TL may be, for example, impedance tuners, open traces, short traces, tuning capacitors, tuning inductors, and phase shifters, but the present invention is not limited thereto.

The RFIC 904 includes switches 930, 932, 934, 936, 938, 940, 942, and 944. The switches 930, 934, 940, and 944 are used to control the receiving (the block 39G RX) or transmitting (the block 39G TX) of high band RF signals (e.g., the 39 GHz RF signals). The switches 932, 936, 938, and 942 are used to control the receiving (the block 28G RX) or transmitting (the block 28G TX) of low band RF signals (e.g., the 28 GHz RF signals). In some embodiments, when the first dipole antenna and the second dipole antenna are under work to transmit the high band RF signals with different polarization directions (e.g., the polarization directions H-Pol. and V-Pol.) to the Z direction, the switch 914 electrically connects the feed line of the first dipole antenna to the diplexer 922, and the diplexer 922 electrically connects the switch 934, so that the switch 934 enables the transmitting of the high band RF signals (39G TX). The switch 916 electrically connects the feed line of the second dipole antenna to the diplexer 924, and the diplexer 924 electrically connects the switch 940, so that the switch 940 enables the transmitting of the high band RF signals (39G TX). At the same time, the first PIFA antenna and the second PIFA antenna are not under work, the switch 912 electrically connects the feed line of the first PIFA antenna to the tuning load TL, and the switch 918 electrically connects the feed line of the second PIFA antenna to the tuning load TL.

In some embodiments, when the first PIFA antenna is under work to receive the high band RF signals from the X direction, the switch 912 electrically connects the feed line of the first PIFA antenna to the diplexer 920, and the diplexer 920 electrically connects the switch 930, so that the switch 930 enables the receiving of the high band RF signals (39G RX). At the same time, the second PIFA antenna, the first dipole antenna, and the second dipole antenna are not under work, the switch 918 electrically connects the feed line of the second PIFA antenna to the tuning load TL, the switch 914 electrically connects the feed line of the first dipole antenna to the tuning load TL, and the switch 916 electrically connects the feed line of the second dipole antenna to the tuning load TL.

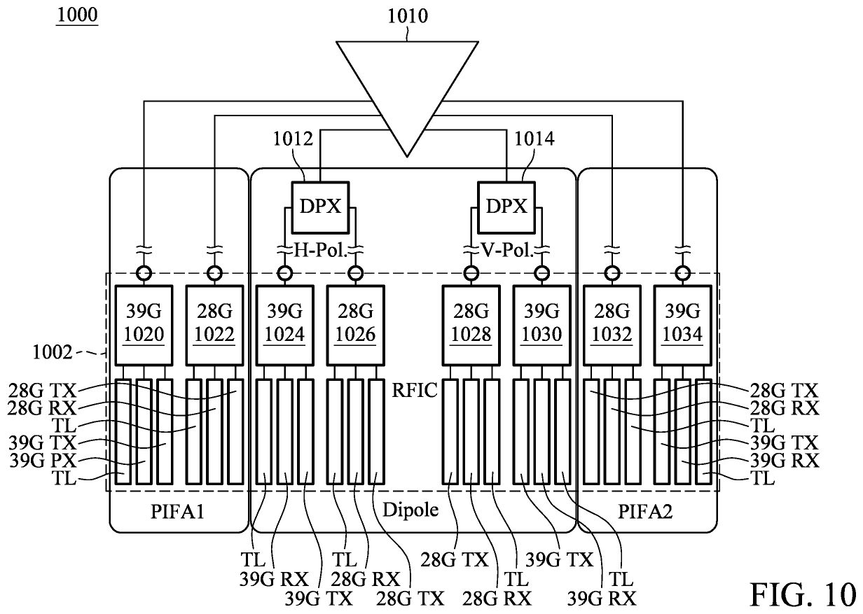

FIG. 10 is a schematic diagram of an antenna control system 1000 in accordance with some embodiments of the present invention. As shown in FIG. 10, the antenna control system 1000 includes an antenna device 1010, a diplexer 1012, a diplexer 1014, and an RFIC 1002. Please refer to FIG. 2A and FIG. 10 at the same time. In some embodiments, the antenna device 1010 includes a first PIFA antenna (PIFA1), a second PIFA antenna (PIFA2), a first dipole antenna (Dipole), and a second dipole antenna (Dipole). The diplexer 1012 is used to electrically connect the feed line of the first dipole antenna to the switch 1024 or the switch 1026. The diplexer 1014 is used to electrically connect the feed line of the second dipole antenna to the switch 1028 or the switch 1030. In some embodiments, the RFIC 1002 includes switches 1020, 1022, 1024, 1026, 1028, 1030, 1032, and 1034. The switches 1020, 1024, 1030, and 1034 are used to control the receiving (the block 39G RX) or transmitting (the block 39G TX) of high band RF signals (e.g., the 39 GHz RF signals). The switches 1022, 1026, 1028, and 1032 are used to control the receiving (the block 28G RX) or transmitting (the block 28G TX) of low band RF signals (e.g., the 28 GHz RF signals).

In some embodiments, when the first dipole antenna and the second dipole antenna are under work to transmit the high band RF signals with different polarization directions (e.g., the polarization directions H-Pol. and V-Pol.) to the Z direction, the diplexer 1012 electrically connects the switch 1024, and the switch 1024 enables the transmitting of the high band RF signals (39G TX). The diplexer 1014 electrically connects the switch 1030, and the switch 1030 enables the transmitting of the high band RF signals (39G TX). At the same time, the first PIFA antenna and the second PIFA antenna are not under work, the switch 1020 electrically connects the high band feed line of the first PIFA antenna to the tuning load TL, and the switch 1022 electrically connects the low band feed line of the first PIFA antenna to the tuning load TL. Similarly, the switch 1032 electrically connects the low band feed line of the second PIFA antenna, and the switch 1034 electrically connects the high band feed line of the second PIFA antenna.

In some embodiments, when the second PIFA antenna is under work to receive the low band RF signals from the −X direction, the switch 1032 enables the receiving of the low band RF signals (28G RX), but the switch 1034 electrically connects the high band feed line of the second PIFA antenna to the tuning load TL. At the same time, the first PIFA antenna, the first dipole antenna, and the second dipole antenna are not under work, the switch 1020 electrically connects the high band feed line of the first PIFA antenna to the tuning load TL, and the switch 1022 electrically connects the low band feed line of the first PIFA antenna to the tuning load TL. The diplexer 1012 electrically connects the switch 1024 or the switch 1026 to the feed line of the first dipole antenna, and the switch 1024 or the switch 1026 electrically connects the feed line of the first dipole antenna to the tuning load TL. Similarly, the diplexer 1014 electrically connects the switch 1028 or the switch 1030 to the feed line of the second dipole antenna, and the switch 1028 or the switch 1030 electrically connects the feed line of the second dipole antenna to the tuning load TL.

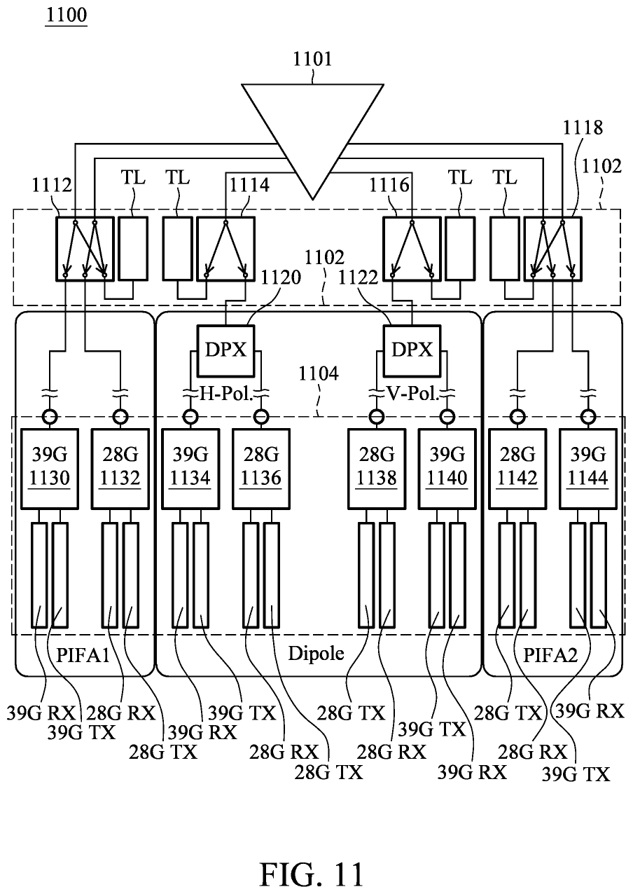

FIG. 11 is a schematic diagram of an antenna control system 1100 in accordance with some embodiments of the present invention. As shown in FIG. 11, the antenna control system 1100 includes an antenna device 1101, an external IC 1102 nearby the antenna device 1101, a diplexer 1120, a diplexer 1122, and an RFIC 1104. Please refer to FIG. 2A and FIG. 11 at the same time. In some embodiments, the antenna device 1101 includes a first PIFA antenna (PIFA1), a second PIFA antenna (PIFA2), a first dipole antenna (Dipole), and a second dipole antenna (Dipole). The external IC 1102 includes switches 1112, 1114, 1116, and 1118, and tuning loads TL. The first input end of the switch 1112 electrically connects the high band feed line of the first PIFA antenna. The second input end of the switch 1112 electrically connects the low band feed line of the first PIFA antenna. The first output end of the switch 1112 electrically connects the switch 1130. The second output end of the switch 1112 electrically connects the switch 1132. The third output end of the switch 1112 electrically connects the tuning load TL. In some embodiments, the input end of the switch 1114 electrically connects the feed line of the first dipole antenna. The first output end of the switch 1114 electrically connects the tuning load TL. The second output end of the switch 1114 electrically connects the diplexer 1120. The input end of the switch 1116 electrically connects the feed line of the second dipole antenna. The first output end of the switch 1116 electrically connects the diplexer 1122. The second output end of the switch 1116 electrically connects the tuning load TL. The first input end of the switch 1118 electrically connects the low band feed line of the second PIFA antenna. The second input end of the switch 1118 electrically connects the high band feed line of the second PIFA antenna. The first output end of the switch 1118 electrically connects the tuning load TL. The second output end of the switch 1118 electrically connects the switch 1142. The third output end of the switch 1118 electrically connects the switch 1144.

The diplexer 1120 is used to electrically connect the feed line of the first dipole antenna to the switch 1134 or the switch 1136. The diplexer 1122 is used to electrically connect the feed line of the second dipole antenna to the switch 1138 or the switch 1140. The RFIC 1104 includes switches 1130, 1132, 1134, 1136, 1138, 1140, 1142, and 1144. The switches 1130, 1134, 1140, and 1144 are used to control the receiving (the block 39G RX) or transmitting (the block 39G TX) of high band RF signals (e.g., the 39 GHz RF signals). The switches 1132, 1136, 1138, and 1142 are used to control the receiving (the block 28G RX) or transmitting (the block 28G TX) of low band RF signals (e.g., the 28 GHz RF signals). In some embodiments, when the first dipole antenna and the second dipole antenna are under work to transmit the low band RF signals with different polarization directions (e.g., the polarization directions H-Pol. and V-Pol.) to the Z direction, the switch 1114 electrically connects the feed line of the first dipole antenna to the diplexer 1120, and the diplexer 1120 electrically connects the feed line of the first dipole antenna to the switch 1136, so that the switch 1136 enables the transmitting of the low band RF signals (28G TX). The switch 1116 electrically connects the feed line of the second dipole antenna to the diplexer 1122, and the diplexer 1122 electrically connects the feed line of the second dipole antenna to the switch 1138, so that the switch 1138 enables the transmitting of the low band RF signals (28G TX). At the same time, the first PIFA antenna and the second PIFA antenna are not under work, the switch 1112 electrically connects the high band feed line and/or the low band feed line of the first PIFA antenna to the tuning load TL, and the switch 1118 electrically connects the high band feed line and/or the low band feed line of the second PIFA antenna to the tuning load TL. In some embodiments, the tuning load TL may be, for example, impedance tuners, open traces, short traces, tuning capacitors, tuning inductors, and phase shifters, but the present invention is not limited thereto.

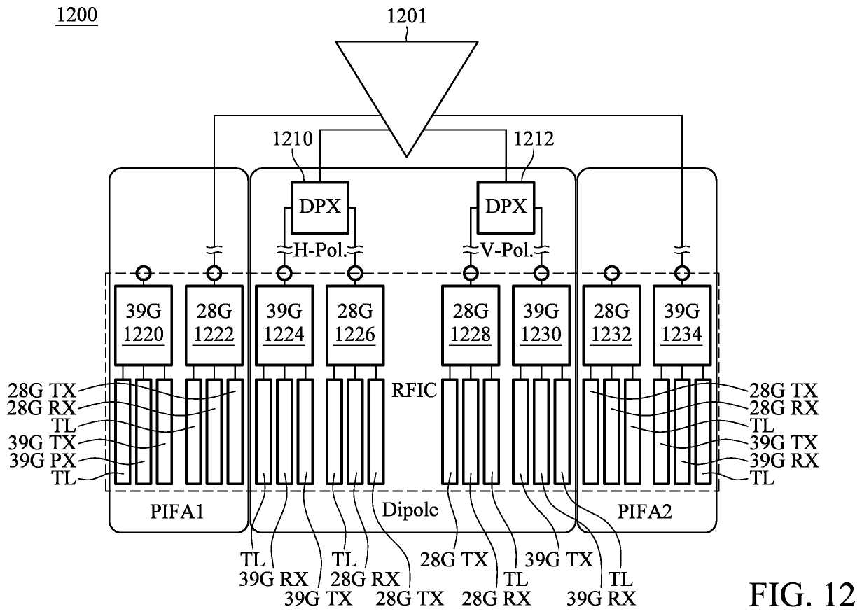

FIG. 12 is a schematic diagram of an antenna control system 1200 in accordance with some embodiments of the present invention. As shown in FIG. 12, the control system 1200 includes an antenna device 1201, an RFIC 1202, a diplexer (DPX) 1210, and a diplexer 1212. Please refer to FIG. 2A and FIG. 11 at the same time. In some embodiments, the antenna device 1201 includes a first PIFA antenna (PIFA1), a second PIFA antenna (PIFA2), a first dipole antenna (Dipole), and a second dipole antenna (Dipole). The diplexer 1210 is used to electrically connect the feed line of the first dipole antenna to the switch 1224 or the switch 1226. The diplexer 1212 is used to electrically connect the feed line of the second dipole antenna to the switch 1228 or the switch 1230. The RFIC 1202 includes switches 1120, 1222, 1224, 1226, 1228, 1230, 1232, and 1234. The switches 1224, 1230, and 1234 are used to control the receiving (the block 39G RX) or transmitting (the block 39G TX) of high band RF signals (e.g., the 39 GHz RF signals), or to electrically connect the feed line of the antenna device 1201 to the tuning loads TL. The switches 1222, 1226, and 1228 are used to control the receiving (the block 28G RX) or transmitting (the block 28G TX) of low band RF signals (e.g., the 28 GHz RF signals), or to electrically connect the feed line of the antenna device 1201 to the tuning loads TL. The switches 1220 and 1232 do not electrically connect any feed lines of the antenna device 1201. The switch 1222 electrically connects the feed line of the first PIFA antenna. The switch 1234 electrically connects the feed line of the second PIFA antenna.

In some embodiments, when the first dipole antenna and the second dipole antenna are under work to transmit the high band RF signals with different polarization directions (e.g., the polarization directions H-Pol. and V-Pol.) to the Z direction, the diplexer 1210 electrically connects the feed line of the first dipole antenna to the switch 1224, and the switch 1224 enables the transmitting of the high band RF signals (39G TX). The diplexer 1212 electrically connects the feed line of the second dipole antenna to the switch 1230, and the switch 1230 enables the transmitting of the high band RF signals (39G TX). At the same time, the switch 1222 electrically connects the feed line of the first PIFA antenna to the tuning load TL, and the switch 1234 electrically connects the feed line of the first PIFA antenna to the tuning load TL.

In some embodiments, when the first PIFA antenna is under work to receive the low band RF signals from the X direction, the switch 1222 enables the receiving of the low band RF signals (28G RX). At the same time, the diplexer 1210 electrically connects the switch 1224 or the switch 1226 to the feed line of the first dipole antenna, and the switch 1224 or the switch 1226 electrically connects the feed line of the first dipole antenna to the tuning load TL. The diplexer 1212 electrically connects the switch 1228 or the switch 1230 to the feed line of the second dipole antenna, and the switch 1228 or the switch 1230 electrically connects the feed line of the second dipole antenna to the tuning load TL. The switch 1234 electrically connects the feed line of the second PIFA antenna to the tuning load TL.

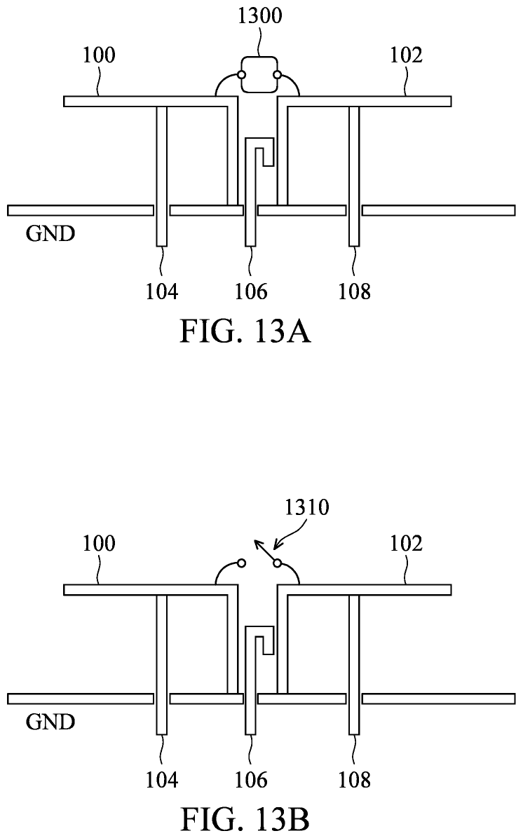

FIG. 13A is a schematic diagram of an antenna device in accordance with some embodiments of the present invention. The difference between the antenna device in FIG. 13A and the antenna device in FIG. 1A is that a tuning circuit 1300 is electrically connected between the radiator 100 and the radiator 102. FIG. 13B is a schematic diagram of the antenna device in FIG. 13A in accordance with some embodiments of the present invention. As shown in FIG. 13B, the tuning circuit 1300 can be a switch 1310, but the present invention is not limited thereto. In some embodiments, when the dipole antenna is under work to transmit the RF signals to the Z direction, the switch 1310 is off to disconnect the connection between the radiator 100 and the radiator 102. In some embodiments, when the dipole antenna is not under work, but one of the PIFA antenna is under work, the 1310 is on to connect the radiator 100 and the radiator 102.

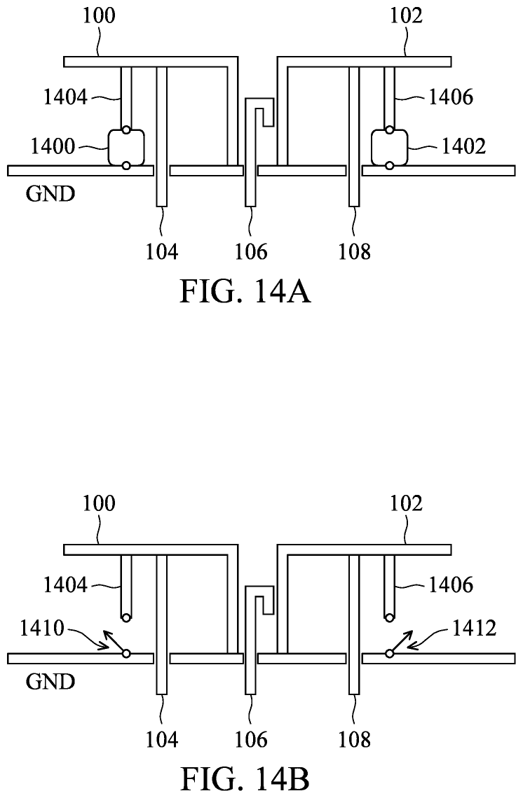

FIG. 14A is a schematic diagram of an antenna device in accordance with some embodiments of the present invention. The difference between the antenna device in FIG. 13A and the antenna device in FIG. 1A is that an open trace 1404 is orthogonally connected to the horizontal portions of the radiator 100, an open trace 1406 is orthogonally connected to the horizontal portions of the radiator 102, a tuning circuit 1400 is electrically connected between the open trace 1404 and the ground GND, and a tuning circuit 1402 is electrically connected between the open trace 1406 and the ground GND.

FIG. 14B is a schematic diagram of the antenna device in FIG. 14A in accordance with some embodiments of the present invention. As shown in FIG. 14B, the tuning circuit 1400 can be a switch 1410. The tuning circuit 1402 can be a switch 1412, but the present invention is not limited thereto. In some embodiments, when the dipole antenna is under work to transmit the RF signals to the Z direction, the switch 1410 is on to connect the connection between the open trace 1404 and the ground GND, and the switch 1412 is on to connect the open trance 1406 and the ground GND. In some embodiments, when the dipole antenna is not under work, the switch 1410 is off to disconnect the connection between the open trace 1404 and the ground GND, or the switch 1412 is off to disconnect the connection between the open trance 1406 and the ground GND.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna device, comprising:
a first antenna, configured to receive or transmit first radio frequency signals to a first direction; and
a second antenna, configured to receive or transmit second radio frequency signals to a second direction;
wherein the first direction is different from the second direction;
wherein radiators of the first antenna and the second antenna are shared.

2. The antenna device as claimed in claim 1, wherein the direction-angle difference between the first direction and the second direction is larger than 30 degrees.

3. The antenna device as claimed in claim 1, wherein the frequency of the first radio frequency signals is the same as that of the second radio frequency signals; or the frequency of the first radio frequency signals is different from that of the second radio frequency signals.

4. The antenna device as claimed in claim 1, wherein the first antenna is a dipole antenna, and the second antenna is a planar inverted-F (PIFA) liked antenna.

5. The antenna device as claimed in claim 1, wherein the first antenna comprises a first feed line, and the second antenna comprises a second feed line; wherein the first feed line electrically couples the first radio frequency signals to the radiators of the first antenna; wherein the second feed line electrically connects or couples the second radio frequency signals to the radiators of the second antenna.

6. The antenna device as claimed in claim 5, wherein the second antenna comprises a tuning circuit; wherein the tuning circuit is electrically connected to the second feed line or is electrically connected to the radiators of the second antenna.

7. The antenna device as claimed in claim 5, wherein the first antenna comprises a tuning circuit; wherein the tuning circuit is electrically connected to the first feed line or is electrically connected to the radiators of the first antenna.

8. The antenna device as claimed in claim 6, wherein the tuning circuit comprises:
a phase shifter, configured to delay the phase of the second radio frequency signals; and
a switch, configured to short the second feed line to a ground, or to open the second feed line.

9. The antenna device as claimed in claim 8, wherein the phase shifter comprises:
a variable capacitor, electrically connected in parallel between the second feed line and the ground, wherein the variable capacitor is configured to change the impedance of the second feed line; and
a transmission line, electrically connected to the second feed line in series, wherein the variable capacitor is configured to delay the phase of the second radio frequency signals.

10. The antenna device as claimed in claim 5, wherein the radiators of the first antenna comprise a first portion and a second portion; the first feed line is disposed between the first portion and the second portion, and the first portion and the second portion form the shape of a pair of gull wings.

11. The antenna device as claimed in claim 10, wherein the radiators of the second antenna comprise the first portion of the radiators of the first antenna, the second feed line, and a ground.

12. The antenna device as claimed in claim 8, wherein when the first antenna receives or transmits the first radio frequency signals to the first direction, the switch shorts the second feed line to the ground; when the second antenna receives or transmits the second radio frequency signals to the second direction, the switch opens the second feed line.

13. The antenna device as claimed in claim 1, further comprising:
a third antenna, configured to receive or transmit third radio frequency signals to a third direction;
wherein the third direction is opposite to the second direction;
wherein the radiators of the first antenna and the third antenna are shared.

14. The antenna device as claimed in claim 13, wherein the third antenna comprises a third feed line; wherein the third feed line electrically connects or couples the third radio frequency signals to the radiators of the third antenna; wherein the frequency of the third radio frequency signals is the same as that of the second radio frequency signals; or the frequency of the third radio frequency signals is different from that of the second radio frequency signals.

15. The antenna device as claimed in claim 13, wherein the third antenna is a planar inverted-F (PIFA) liked antenna.

16. The antenna device as claimed in claim 1, wherein the polarization direction of the first radio frequency signals is the same as the second direction or the opposite direction of the second direction; wherein the polarization direction of the second frequency signals is the same as the first direction or the opposite direction of the first direction.

17. The antenna device as claimed in claim 1, further comprising:
a fourth antenna, configured to receive or transmit fourth radio frequency signals to the first direction;
wherein the polarization direction of the fourth radio frequency signals is a fourth direction;
wherein the fourth direction is orthogonal to the second direction.

18. The antenna device as claimed in claim 17, wherein the fourth antenna comprises a fourth feed line; wherein the fourth feed line electrically couples the fourth radio frequency signals to the radiators of the fourth antenna; wherein the frequency of the fourth radio frequency signals is the same as that of the first radio frequency signals; or the frequency of the fourth radio frequency signals is different from that of the first radio frequency signals.

19. The antenna device as claimed in claim 17, wherein the fourth antenna is a dipole antenna.

20. The antenna device as claimed in claim 18, wherein the radiators of the fourth antenna comprise a third portion and a fourth portion; the fourth feed line is disposed between the third portion and the fourth portion, and the third portion and the fourth portion form the shape of a pair of gull wings.
